(19) United States
(12) Patent Application Publication
(10) Pub. No.: US 2012/0274942 A1
(43) Pub. Date: Nov. 1, 2012

(54) SIGNAL PROCESSING

(75) Inventor: Edward Austin, Guildford Surrey (GB)

(73) Assignee: STINGRAY GEOPHYSICAL LTD., Guildford, SU (GB)

(21) Appl. No.: 13/504,280

(22) PCT Filed: Oct. 26, 2010
(86) PCT No.: PCT/GB2010/001985

§ 371 Date: Jun. 22, 2012

(30) Foreign Application Priority Data
Oct. 29, 2009 (GB) 0919017.4

(51) Int. Cl. G01V 1/18; G01B 9/02

(52) U.S. Cl. 356/450

(57) ABSTRACT

There is described a method and apparatus for processing light pulses returned from an optical sensor, wherein the light pulses are applied to two interferometer arrangements, a first interferometer arranged simply to superimpose two pulses and detect a first resulting value, and the other interferometer being arranged to apply a relative phase shift of about π/2 before super-imposing the two pulses to detect a second resulting value. The relative phase shift is applied by shifting the phase of one or both of the pulses. The first and second resulting values are divided to give a third value, representative of the sensor state. A seismic sensor array using such an apparatus to process returning pulses is also described.

The present invention relates to signal processing, and is particularly concerned with measurement of phase difference between pulses in a series of signal pulses, and finds utility in the processing of signals returned from a plurality of sensors in a sensor array.

The present invention is particularly applicable in seismic sensing arrays, which use a plurality of seismic sensors laid out at known locations over an area to detect reflected seismic waves from sub-surface formations in order to produce an image of the subsurface structure.

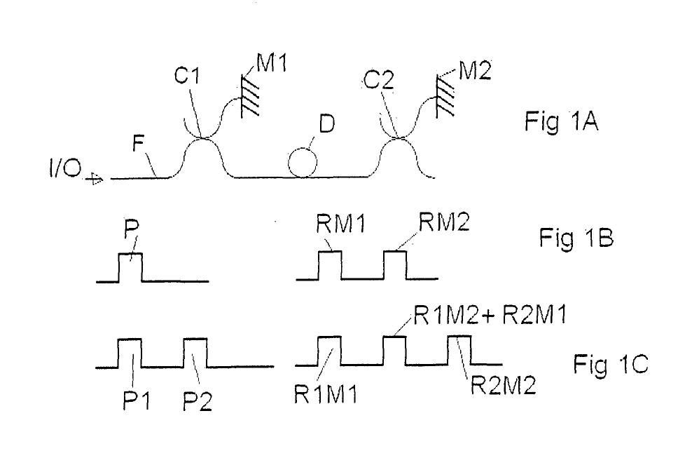

Arrays of fibre optic sensors are known in which each sensor comprises a coil D (shown schematically in FIG. 1A) of optical fibre with a mirror coupled to the fibre at each end of the coil. A light pulse P (FIG. 1B) is applied to an input end of the fibre F, and this single input pulse P travels along the fibre F and is reflected at the mirrors M1 and M2 to generate a pair of return pulses R1 and R2, one from each mirror, at the input end of the fibre. The first pulse R1 to return is from the mirror M1 between the sensor coil D and the input end I/O, and is light which has travelled from the input end to this first mirror and back. The second pulse R2 to return is from the mirror M2 beyond the sensor coil D (viewed from the input end), and is light which has travelled from the input end I/O through the sensor coil D, to this second mirror M2, back through the sensor coil D and to the input end I/O.

Techniques have been developed for interrogating arrays such of fibre optic sensors, in which two optical pulses P1 and P2 (FIG. 1c) of similar wavelengths but differing slightly in optical frequency are input into the sensor array with an interval between the pulses arranged such that the returning pulse R1M2, which is the reflection of the first pulse P1 from the mirror M2, arrives back at the input end I/O at the same time as, and superimposed on, the return pulse R2M1, which is the reflection of the second input pulse P2 in the mirror M1. By making pulses P1 and P2 of differing frequencies f1 and f2, the superimposed pulses exhibit an interference beat frequency f2-f1. The phase of the returning beat tone relative to the applied optical difference tone is an indication of the length of the delay caused by sensor coil D to the signal pulse P1 as it passes twice through the coil D to form return pulse R1M2. This phase delay is therefore representative of the length of the fibre optic delay coil D. The skilled man will appreciate that the beat tone must be observed for one complete cycle period in order to determine the phase shift accurately.

This technique however has two inherent limitations. Firstly, the derived phase difference is an average value of the phase difference over the entire beat cycle, and is not a true instantaneous measurement. Secondly, if the phase difference changes by more than 2π during the measurement interval, so-called “overscale” occurs it is impossible to accurately reconstruct the sensor phase.

The present invention seeks to provide a method for interrogating an optical sensor or sensor array in which instantaneous measurement of the length of the or each sensor coil is provided.

An advantage of the instantaneous measurement technique over the previous technique is that the repetition rate required to interrogate an optical sensor is reduced, and thus using time division multiplexing techniques a larger number of optical sensors may be interrogated. Alternatively, a similar number of sensors may be interrogated with a higher frequency (ie more interrogations in the same time interval). In an optical sensor array, this can mean that more optical sensors can be placed on a single fibre and addressed by a single wavelength of light. The overall number of fibres needed to address the sensors in a given array may then be reduced significantly.

According to a first aspect of the invention, there is provided an apparatus for processing first and second optical signal pulses from an optical sensor, comprising:
a first interferometer in which the first and second pulses are superimposed and a first value detected;
means for applying a relative phase shift between the first and second pulses;
a second interferometer in which the relatively phase-shifted pulses are superimposed and a second value detected;
means for dividing the first value by the second value to generate a third value; and
means for deriving data indicative of the state of the optical sensor on the basis of the third value.

The relative phase shift may be applied in various ways. In a first alternative, a phase shift is applied to one of the pulses, while the other is untreated. In a second alternative, a phase shift in a first direction is applied to one of the pulses, and a phase shift in the opposite direction is applied to the other of the pulses. Preferably, these two phase shifts are of the same magnitude. In a third alternative, a phase shift may be applied to both of the pulses in the same direction, but the phase shifts will be of different magnitudes.

A second aspect of the invention provides a method for determining an optical path length in an optical sensor, in which an interrogating light pulse applied to the sensor produces a first returning light pulse unmodified by the sensor and a second returning light pulse modified by the sensor, the method comprising the steps of superimposing the first and second returning light pulses and detecting the result as a first value, applying a phase shift to one of the first and second returning light pulses to generate a third light pulse, superimposing the third light pulse on the other of the first and second returning pulses and detecting the result as a second value, and using the first value and the second value to obtain a third value representing a measure of instantaneous path length of the sensor.

In one embodiment, in addition to applying a phase shift to one of the pulses, a different phase shift is applied to the other of the returning light pulses and the two phase-shifted light pulses are superimposed and the result detected as the second value. The different phase shift may be a phase shift of equal magnitude in the opposite direction, or may be a phase shift of different magnitude in the same direction.

A third aspect of the invention provides a seismic sensing array comprising a plurality of optical sensors, and an apparatus for processing a series of light pulses returning from each sensor of the array of sensors in response to an input pulse, the apparatus comprising:
a first interferometer in which first and second pulses are superimposed and a first value detected;
means for applying a phase shift to one of the first and second pulses;
a second interferometer in which the other of the first and second pulses and the phase-shifted pulse are superimposed and a second value detected;
means for dividing the first value by the second value to generate a third value; and
means for deriving data indicative of the state of the optical sensor on the basis of the third value.

A further aspect of the invention provides an apparatus for processing a series of light pulses returning from sensors of an array of sensors in response to an input pulse, the apparatus comprising:
a first interferometer in which first and second pulses are superimposed and a first value detected;
means for applying a relative phase shift between the first and second pulses;
a second interferometer in which the relatively phase-shifted first and second pulses are superimposed and a second value detected;
means for dividing the first value by the second value to generate a third value; and
means for deriving data indicative of the state of the optical sensor on the basis of the third value.

The relative phase shift may, as before, be produced by applying a phase shift to one of the pulses, or by applying different phase shifts to both of the pulses. Embodiments of the invention are foreseen in which the light pulses applied to the sensor include components at two different wavelengths, and the resulting returning pulses include components of each wavelength which are separated by a demultiplexer and superimposed. The difference in wavelengths between the two components of the light pulses applied to the sensor may be chosen to be any value. In a preferred embodiment the difference is 50 GHz.

By applying the method simultaneously to two or more different wavelength components of the returning pulses of light, two or more respective “third values” are thereby obtained. The “third values” can be computed to produce an instantaneous measurement representing the state of the sensor.

Embodiments of the invention will now be explained in detail with reference to the accompanying drawings, in which:

FIGS. 1A to 1C are schematic diagrams referred to above in relation to the prior art;

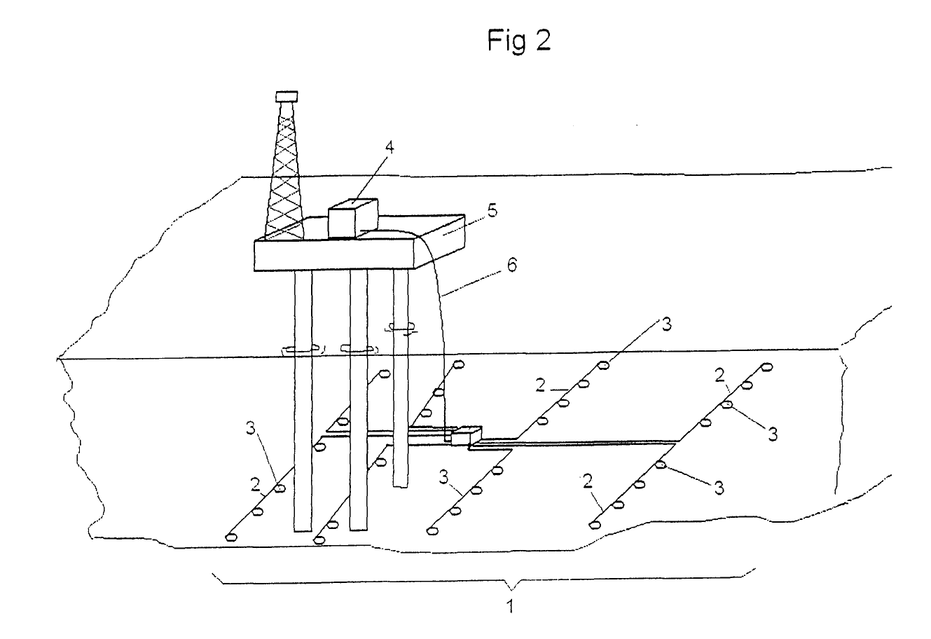

FIG. 2 is a schematic perspective view of an undersea seismic array;

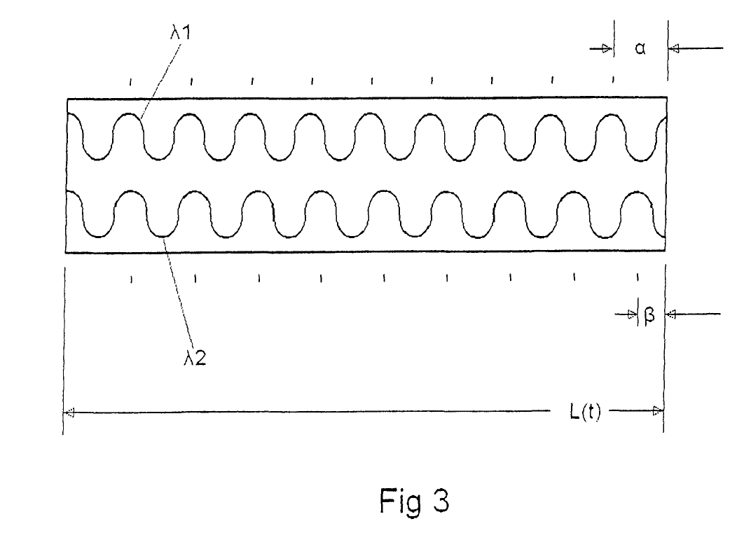

FIG. 3 is a schematic illustration of light of two different wavelengths passing through an optical fibre;

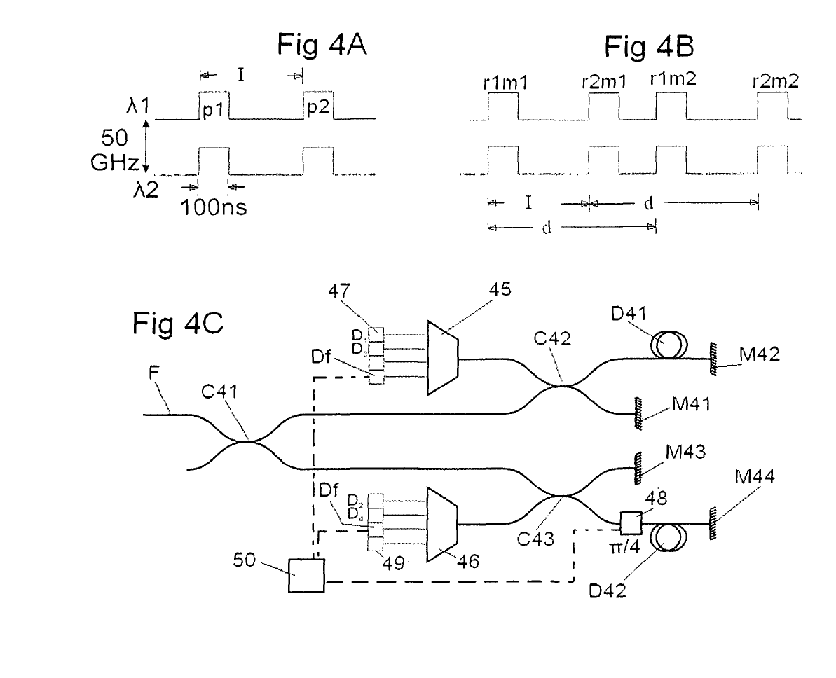

FIG. 4A illustrates the wavelength and timing relationship between optical pulses applied to the seismic array in embodiments of the invention;

FIG. 4B illustrates the timing relationship between optical pulses returned from a sensor in the seismic array;

FIG. 4C shows an arrangement for decoding returned signal pulses in accordance with one embodiment of the invention;

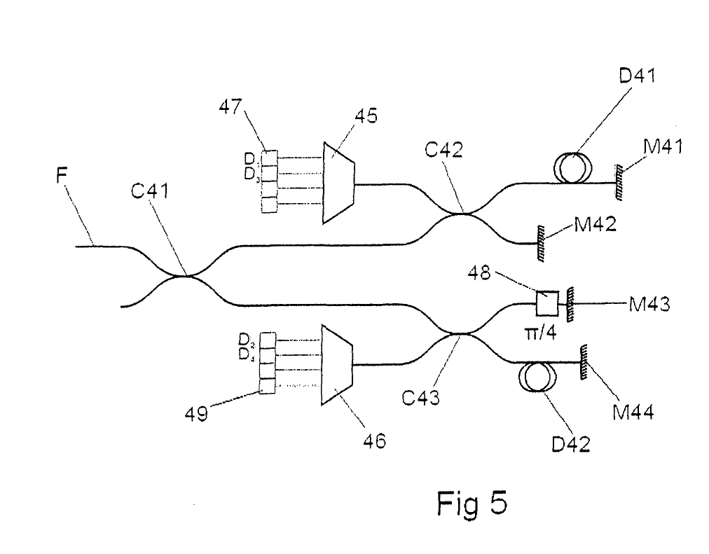

FIG. 5 shows an arrangement for decoding returned signal pulses in accordance with a second embodiment of the invention;

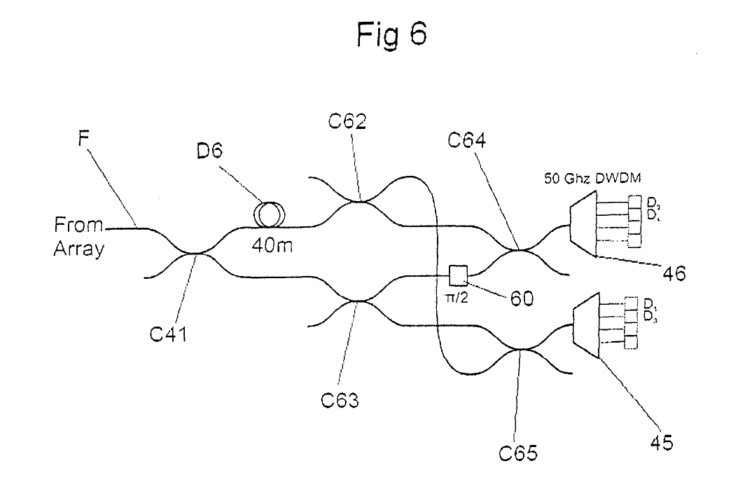

FIG. 6 shows a further arrangement for decoding returned signal pulses in accordance with a third embodiment of the invention; and

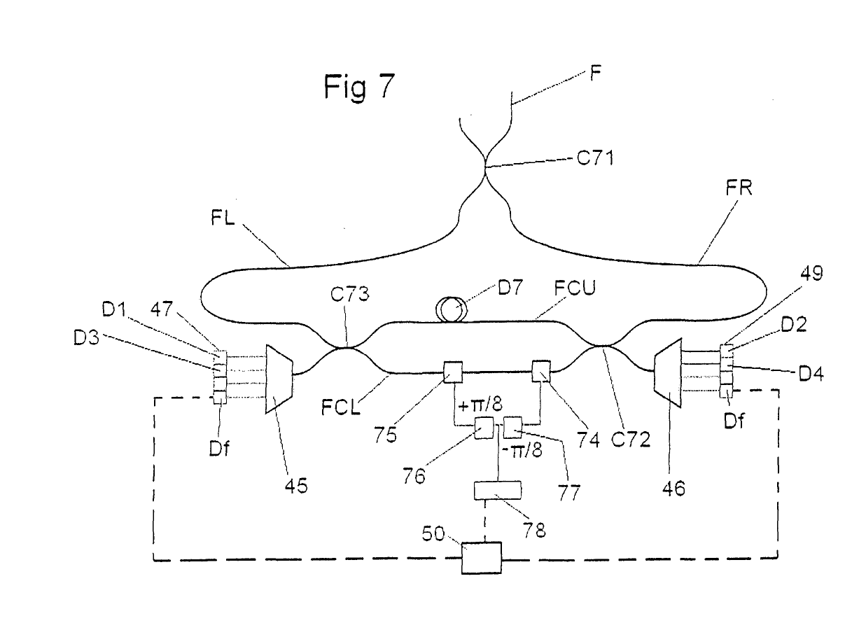

FIG. 7 shows an arrangement for decoding returned signal pulses in accordance with a fourth embodiment of the invention.

Referring now to the Figures, FIG. 2 is a schematic view showing a seismic array deployed on the seabed. The seismic array 1 comprises a number of seismic cables 2 laid in substantially parallel lines on the seabed. At intervals along each cable 2, sensing units 3 are provided. Each sensing unit 3 includes accelerometers and a pressure transducer to detect seismic vibrations in the seabed, and acoustic waves in the seawater. The sensing units 3 are connected to an operating system 4 via optical fibres within the seismic cables 2. In the illustrated embodiment, the operating system 4 is housed on a platform 5 and connected by a riser 6, but the operating system may, for example, be provided on a ship, or on dry land if the area of interest is close enough inshore. The operating system 4 may be permanently attached to the seismic cables 2 of the array 1. Alternatively, the operating system 4 may be releaseably connected to the seismic array 1, so that the same operating system may be transported and selectively connected to a number of different seismic arrays. The operating system 4 provides input light pulses which are led to the sensors within the sensing units 3, and receives and correlates the returning pulse trains to provide seismic data relating to the strata underlying the seismic array 1. While the illustrated implement is a seismic sensor array deployed on a seabed, the present invention is also applicable to sensor arrays deployed on dry land and to arrays towed by a vessel in water.

Each of the sensors in a sensor unit comprises a coil of optical fibre arranged such that its length is modulated when the sensor undergoes an acceleration or pressure change, such as when a seismic wave impacts on the sensor. The sensor is interrogated by measuring the length of the optical fibre, and the present technique seeks to provide a means of measuring the instantaneous length of the fibre, rather than measuring an average length of the fibre over a time interval.

FIG. 3 schematically illustrates a sensor coil fibre F of instantaneous round-trip length l(t). The coil is interrogated by applying pulses of light at two distinct wavelengths, λ1 and λ2. The total length l(t) of the fibre forming the coil can be expressed as:

λ1×μ_{λ1}.×(n+α/2π)

where n is an integer, α is an instantaneous phase angle (in radians), and μ_{λ1} is the refractive index of the fibre for light of wavelength λ1. In other words, the length l(t) of the fibre forming the coil is such that n complete wavelengths of light at wavelength λ1, plus a fraction α of a wavelength λ1, fill the coil.

Likewise, for the light of wavelength λ2, m complete wavelengths of light at wavelength λ2, plus a fraction β of a wavelength λ2, fill the coil. Thus the length l(t) of the fibre forming the coil can be expressed mathematically as

λ2×μ_{λ2}×(m+β/2π)

where m is an integer, β is an instantaneous phase angle (in radians), and μ_{λ2} is the refractive index of the fibre for light of wavelength λ2. Since the light of both wavelengths is present in the same coil, with the length l of the coil varying with time t, then instantaneously:

l(t)=μ_{λ1}.λ1.(n+α/2π)=μ_{λ2}.λ2.(m+β/2π)

where

0≦α<2π

and

0≦β<2π

and

μ_{λ1} and μ_{λ2} are the refractive indices of the fibre for light of wavelengths λ1 and λ2, respectively.

Now, if the wavelengths λ1 and λ2 and the length of the sensor coil are chosen such that, throughout the full scale deflection of the sensor, the number of whole wavelengths at λ2 held in the sensor coil is equal to the number of whole wavelengths at λ1 held in the sensor coil, then at every instant n is equal to m. Then, by measuring α and β at the same instant, n can be calculated using the equation above, and l(t) at that instant may be uniquely found by substituting for n and α or β as required. In this way, the total optical phase held within the sensor can always be accurately determined, even when rapidly changing.

The calculation is simplified by neglecting any difference in the refractive index μ of the fibre material for light of wavelength λ1 as compared to light of wavelength λ2, and assuming that μ_{λ1}=μ_{λ2}.

To measure α and β, the optical phase difference between the light which has passed through the sensor coil and the light which has not has to be measured.

FIG. 4C illustrates a first apparatus for performing such instantaneous measurements.

In FIG. 4C, signal pulses from a sensor array are input via optical fibre F. The pulses are fed to a first coupler C41, which splits and feeds the signals to second and third couplers C42 and C43.

Coupler C42 has three output branches, one leading to a first mirror M41 and a second leading to a first delay coil D41 and then to a second mirror M42. The third output branch of coupler C42 leads to a wavelength division demultiplexer 45, which feeds an array of detectors 47.

Likewise, coupler C43 has three output branches, one leading to a third mirror M43. A second branch from coupler C43 leads to a π/4 phase shifter 48, which then feeds the signal to a second delay coil D42 and then to a fourth mirror M44. The third output branch of coupler C42 leads to a wavelength division multiplexer 46, which feeds a second array of detectors 49.

The detectors in arrays 47 and 49 may be conventional optical “square law” detectors.

In operation, a signal pulse containing at least two wavelengths enters along fibre F and is split at coupler C41 to be fed to the couplers C42 and C43. At coupler C42, the signal is fed to the first mirror M41 where it is reflected back to coupler C42 and then passed on to demultiplexer 45 where it is split into separate wavelength components which are then fed to respective detectors D1, D3 of the detector array 47. At the same time, the incoming signal is fed from the coupler C42 to the first delay coil D41, and is reflected at the second mirror M42 to pass again through the delay coil D41 and back to coupler C42. The delayed signal is then fed by coupler C42 to demultiplexer 45 where it is also split into separate wavelength components which are then fed to respective detectors D1, D3 of the detector array 47.

The detectors D1, D3 of the detector array 47 thus receive their respective wavelength components of the signal, followed by their respective wavelength components of the delayed signal.

In a similar fashion, the detectors D2, D4 of the detector array 49 first receive the signal pulse via coupler C43 and third mirror M43, and then receive a delayed and phase-shifted signal which has passed through the phase shifter 48 and second delay coil D42, been reflected at the fourth mirror M44, and passed back through the second delay coil D42 and the phase shifter 48. At each passage through the phase shifter 48, the signal's phase is altered by π/4. Thus, when the delayed and phase-shifted signal arrives at the multiplexer 46, it has undergone a delay plus a total phase shift of π/2 relative to the signal returning from third mirror M43.

While the present specification refers to phase changes of π/2, it will be appreciated by the skilled man that a phase difference of slightly more or slightly less than π/2 may be acceptable with negligible reduction of performance.

FIG. 4A illustrates two input pulses P1 and P2 applied to a sensor array. In this embodiment, pulses P1 and P2 are of 100 ns duration, and are launched into the sensor array at an interval I. FIG. 4B illustrates the four-pulse train which returns from a sensor in the array, in response to the input pulses P1 and P2. Returning pulse R1M1 (the reflection of the first pulse P1 from the first mirror M1 of the sensor) is followed after an interval I by returning pulse R2M1 (the reflection of pulse P2 from the first mirror). At an interval d from the first returning pulse, the third returning pulse R1M2 (the reflection of the first pulse P1 from the second mirror M2 of the sensor) arrives. Likewise, the fourth returning pulse R2M2 (the reflection of the second pulse P2 from the second mirror of the sensor) arrives an interval of I+d after the first returning pulse R1M1. The delay d is governed by the length of the sensor coil, and the interval I is arranged in relation to the delay d so that the returning pulses from each sensor arrive back at the interrogator separately, and can thus be individually processed in the interrogator. The timing of application of pulses, and the lengths of the fibres connecting the sensors in the array are arranged such that each returning pulse arrives separately at the detector. Delay coils may be introduced between sensors in the array in order to achieve the desired separation between the returning pairs of pulses.

In response to each pulse P1 or P2 applied, each sensor of the sensor array returns two pulses, the first of which R1M1, R2M1 has not passed through the sensing coil of the sensor, and the second of which R1M2, R2M2 has passed twice through the sensor coil.

In the prior art arrangement described above, the sensor array is interrogated by applying two pulses spaced apart by an interval equal to the nominal delay caused by a sensor coil, so that the returning pulse train comprises a number of superimposed pairs. In the present arrangement, interrogating pulses are applied to the sensor array at a time interval selected so that the returning pulses are separated, and each sensor of the sensor array returns first an “unmodified” pulse R1M1, R2M1, and then a “modified” pulse R1M2, R2M2 which has passed through the sensor coil. The temporal separation of these returned pulses is important to the processing method of the present invention, as will be apparent from the following description.

Those skilled in the art will appreciate that the apparatus illustrated in FIG. 4C comprises a pair of interferometers. The train of returning pulses is split by the coupler C41 and fed to the two interferometers.

In the “upper” interferometer (which is constituted by coupler C42, first delay coil D41 and first and second mirrors M41 and M42), an “unmodified” pulse R1M1 from a mirror immediately preceding a sensor coil of the sensor array is delayed by an amount d, and superimposed on a “modified” pulse R1M2 returning from a mirror immediately following that coil of the sensor array. The delay coil D41 achieves this superposition of the returning pulses.

The detectors D1 and D3 of the upper interferometer, measure the superposed signals for the respective wavelengths λ1 and λ2.

In the “lower” interferometer (which is constituted by coupler C43, phase shifter 48, second delay coil D42 and third and fourth mirrors M43 and M44), an “unmodified” pulse R1M1 passes through the phase shifter 48 and the delay coil D42 to be reflected from the fourth mirror M44 back through the delay coil and phase shifter to the coupler C43. A “modified” pulse R1M2 is reflected from the third mirror M43 and arrives at coupler C43 simultaneously with the phase-shifted “unmodified” pulse R1M1, and the two pulses are superposed and fed to the demultiplexer 46 which splits the superposed pulse pair into its λ1 and λ2 wavelength components, and directs each wavelength component to a respective detector D2 or D4.

The detectors D2 and D4 of the lower interferometer, measure the superposed signals for the respective wavelengths λ1 and λ2 with a π/2 overall phase shift between the first and second returning signals.

Thus, D1 (in detector array 47) measures the “in-phase” signal at λ1 and D2 (in detector array 49) measures the π/2 shifted signal at λ1. Similarly, D3 (in detector array 47) and D4 (in detector array 49) measure the same signals at λ2, all these measurements representing instantaneous values at the same instant in time.

Those skilled in the art will appreciate that by dividing the instantaneous value measured at D2 by the value measured at D1, it is possible to calculate tanα. Likewise, by dividing the instantaneous value measured at D3 by the value measured at D4, it is possible to calculate tanβ. Thus we have:

$$α = a tan ( \frac{{D}_{2}}{{D}_{1}} )$$

$$β = a tan ( \frac{{D}_{3}}{{D}_{4}} )$$

Then the overall number of periods is computed by finding the largest integer n such that

$$n \leq \frac{λ 2 \cdot β - λ 1 \cdot α}{2 Π ( λ 1 - λ 2 )}$$

And n can then be substituted with α and/or β to find the instantaneous value of l(t) using

l(t)=μ_{λ1}.λ1.(n+α/2π)=μ_{λ2}.λ2.(m+β/2π)

where n=m for all expected l(t). Those skilled in the art will realize that when two input pulses are applied, with difference frequency f, the value of l(t) demodulated from the returning pulse R2M1+R1M2 will also be modulated at f. This may be used for detector noise reduction.

FIGS. 5, 6 and 7 illustrate alternative arrangements for the optical components to process incoming optical pulses. In the descriptions of these Figures, like reference symbols will be used to describe corresponding components to those seen in FIG. 4B.

In FIG. 5, the “upper interferometer” is arranged in the same way as in FIG. 4, with coupler C42 receiving the signals from coupler C41 and relaying the signals to first mirror M41 and to delay coil D41 and second mirror M42. Returning signals from the mirrors M41 and M42 are routed by coupler C42 to demultiplexer 45 and detector array 47, where detectors D1 and D3 interrogate the sensors using wavelengths λ1 and λ2 respectively.

The “lower interferometer” differs from that of FIG. 4 in that the phase shifter 48 and the delay coil D42 are sited on different branches of the interferometer. In this embodiment, the multiplexer first receives a phase-shifted signal from the phase shifter 48 and third mirror M43, and then receives the delayed signal from the fourth mirror M44. When the returning pulses are superimposed, however, the detection result at the detectors D2 and D4 is the same, irrespective of whether one signal is phase shifted and the other is delayed, or whether one signal passes to the multiplexer without treatment while the other signal is both phase-shifted and delayed.

FIG. 6 illustrates a third alternative arrangement for dealing with the returning signal pulses. In this arrangement, pulses returning from the array along the fibre F are fed to a first coupler C41. One branch of the coupler C41 leads to a delay coil D6 and then to a second coupler C62. The other branch of first coupler C41 leads to a third coupler C63.

One output branch of third coupler C63 leads to a π/2 phase shifter 60, which is in turn coupled to an input of a fourth coupler C64. Another input of the fourth coupler C64 is fed with the delayed signal from second coupler C62, and an output of the fourth coupler C64 is fed to a demultiplexer 46, which separates the wavelengths and feeds them to detectors D2 and D4.

The other output branch of third coupler C63 leads to an input of a fifth coupler C65. Another input of the fifth coupler C65 is fed with the delayed signal from coupler C62, and an output of the fifth coupler C65 is fed to a demultiplexer 45, which separates the wavelengths and feeds them to detectors D1 and D3.

As in the arrangement of FIG. 4, detectors D1 and D3 of the interferometer constituted by coupler C41, delay coil D6, and couplers C62, C63 and C65, measure the superimposed signals for the respective wavelengths λ1 and λ2. The unprocessed signal is fed to the coupler C65 via couplers C41 and C63, while the delayed signal is fed to the coupler C65 via delay coil D6 and coupler C62.

The detectors D2 and D4 of the interferometer which is constituted by coupler C41, delay coil D6, couplers C62 and C63, phase shifter 60 and coupler C64, measures the superimposed signals with a π/2 overall phase shift for the respective wavelengths λ1 and λ2. The delayed signal is fed to the coupler C64 via delay coil D6 and coupler C62, while the phase-shifted signal is fed to the coupler C64 via coupler C41, coupler C63, and phase shifter 60.

FIG. 7 illustrates a further arrangement for providing outputs to calculate the values of α and β. In this embodiment, each “unmodified” pulse is delayed and superimposed on a pulse which has been “modified” by applying to it a phase shift of π/4 in either a positive or a negative sense, so that when the outputs of the detectors D1 and D3 and the outputs of detectors D2 and D4 are divided, the result is still tan α or tanβ.

In the arrangement shown in FIG. 7, signals from the array are input to a coupler C71 and from there are led to respective inputs of second and third couplers C72 and C73.

An output of coupler C72 is led to one end of a delay coil D7, the other end of the delay coil D7 being connected to coupler C73.

Another output of coupler C72 is led to a first acousto-optic modulator 74 (upshift), which adds RF signal R1 to the optical signal. From the first acousto-optic modulator 74, the optical signal is led to a second acousto-optic modulator 75 (downshift), which subtracts RF signal R1 from the optical signal. The operation of the AOM as described in “Optical phase shifting with acousto-optic devices” (Li et al, OPTICS LETTERS, Vol. 30, No. 2, Jan. 15, 2005) will be such that the phase differences will be added, so light passing through modulator 74 and then through modulator 75 will suffer two successive phase shifts of π/8 in the same sense, resulting in a total phase shift of π/4. If the signals R1 and R2 are tuned to the characteristic frequency of the acousto-optic modulator, but with a relative total phase shift of π/8, then the light emerging from modulator 74 will have the same wavelength as light entering the modulator 75 but with an induced phase shift of π/4 in a “positive” sense. From second acousto-optic modulator 75, the signal is led to coupler C73.

The two acousto-optic modulators 74 and 75 are driven by a common RF source 78, the driving signals to each of the acousto-optic modulators passing through respective phase shifters 76 and 77 which apply phase shifts of π/8 in opposite senses to the respective modulators 74 and 75. Since the modulators 74 and 75 are coupled “back-to-back”, a pulse passing through the two modulators undergoes two successive phase shifts of π/8 in the same sense, resulting in a total phase shift of π/4.

Coupler C72 also feeds a wavelength demultiplexer 46, which in turn feeds detectors D2 and D4 in detector array 49. Likewise, coupler C73 also feeds a wavelength demultiplexer 45, which in turn feeds detectors D1 and D3 in detector array 47.

The acousto-optic modulators 74 and 75 are bidirectional devices, as of course is delay coil D7. In this arrangement, a signal arriving along fibre F is split into two parts by the coupler C71. The part of the signal which passes along fibre FR on the right-hand side (as seen in the Figure) arrives at the coupler C72, where it is split and fed to the upper FCU and lower FCL central fibres. The upper fibre FCU takes the signal through delay coil D7, and thus a delayed signal will arrive at coupler C73. The lower fibre FCL takes the signal through the pair of back-to-back acousto-optic modulators 74 and 75. In the modulator 74, a “negative” phase shift of π/4 is applied to the signal, and the phase-shifted signal is then passed to the second acousto-optic modulator 75 where a further “negative” phase shift of π/4 is applied. The signal is then passed to coupler 73 (with a total negative phase shift of π/2), where it is output to the wavelength demultiplexer 45 and is fed to the detectors D1 and D3 of the detector array 47.

Similarly, the part of the signal which passes along fibre FL on the left-hand side (as seen in the figure) arrives at the coupler C73, where it is split and fed to the upper and lower central fibres FCU and FCL. The upper fibre FCU takes the signal through delay coil D7, and thus a delayed signal will arrive at coupler C72. The lower fibre FCL takes the signal through the pair of back-to-back acousto-optic modulators 74 and 75, this time in the opposite direction from that of the previously-described signal. In the modulator 74, a “positive” phase shift of π/8 is applied to the signal, and the phase-shifted signal is then passed to the second acousto-optic modulator 75 where a further “positive” phase shift of π/8 is applied. The signal is then passed to coupler (with a total positive phase shift of π/4), where it is output to the wavelength demultiplexer 45 and is fed to the detectors D1 and D3 of the detector array 47.

As in the previously-described embodiments, the purpose of the delay coil D7 is to ensure that the “unmodified” pulse R1M1 arriving from each sensor is delayed so that it arrives at the coupler 72 or 73 simultaneously with the “modified” pulse R1M2, (or R2M1 with R2M2) and the superimposed pulses are then applied to the demultiplexers 46 and 45, and on to the detectors.

In a further alternative embodiment, similar to that of FIG. 7, the delay coil D7 may be placed in the lower central fibre FCL rather than in the upper central fibre FCU. In such an arrangement, an “unmodified” pulse R1M1 (or R2M1) arriving from each sensor is delayed and phase-shifted, and arrives at the coupler 72 or 73 simultaneously with a “modified” pulse R1M2 (or R2M2), to be superimposed and passed to the demultiplexer 46 or 45 and on to the detectors.

In the embodiment illustrated in FIG. 4C, an optional additional feature is shown in which a detector Df in each of the detector arrays 47 and 49 is used in a feedback control system to control the phase shifter 48. In this schematically-shown arrangement, control light of a different wavelength from λ1 or λ2 is applied directly to the fibre F, without passing through the sensor array, either as pulses at an interval which results in the control light pulses being superimposed at the detectors Df, or continuously. The phase difference between superimposed pulse pairs, or superposed sections of the continuous light, may then be measured, and this measurement relayed to a control unit 50, which is operable to control the phase difference being applied by the phase shifter 48. Such a feedback control arrangement may be advantageously adopted where the phase shifter 48 is a PZT device. A similar arrangement is shown in FIG. 7, where a control unit 50 receives inputs from detectors Df in the two detector arrays, and outputs control signals to the RF source 78 to control the phase shifts applied by the acousto-optical modulators 74 and 75. The feedback control shown in FIG. 7 is optional, and may not be required.

In addition to PZT devices and acousto-optical modulators, the phase shift may also be achieved by means of a phase modulator material such as lithium niobate.

1-36. (canceled)

37. An apparatus for processing first and second optical signal pulses from an optical sensor, comprising:
a first interferometer in which the first and second pulses are superimposed and a first value detected at a first detector means;
a second interferometer including means for applying a relative phase shift between the first and second pulses, in which the relatively phase shifted first and second pulses are superimposed and a second value detected at a second detector means;
means for dividing the first value by the second value to generate a third value; and
means for deriving data indicative of the state of the optical sensor on the basis of the third value.

38. The apparatus according to claim 37, wherein:
the first interferometer includes means for applying a predetermined phase shift to one of the pulses in a first direction, and means for superimposing the first and second pulses; and
the second interferometer includes means for applying a predetermined phase shift to one of the pulses in a second direction opposite to the first direction, and means for superimposing the first and second pulses.

39. The apparatus according to claim 38, wherein the means for superimposing the first and second pulses in each of the first and second interferometers comprises a delay means for applying a delay to the first pulse.

40. The apparatus according to claim 39, wherein the means for applying a predetermined phase shift in each of the first and second interferometers is operable to apply a phase shift to the first pulse or to the second pulse, and the delay means is operable to delay the first pulse.

41. The apparatus according to claim 37, wherein each of the first and second detector means comprises a demultiplexer and a detector.

42. A method for determining an optical path length in an optical sensor, in which an interrogating light pulse applied to the sensor produces a first returning light pulse unmodified by the sensor and a second returning light pulse modified by the sensor, the method comprising:
superimposing the first and second returning light pulses and detecting the result as a first value;
applying a phase shift to one of the first and second returning light pulses to generate a third light pulse;
superimposing the third light pulse on the other of the first and second returning light pulses and detecting the result as a second value; and
using the first value and the second value to obtain a third value representing a measure of instantaneous path length of the sensor.

43. The method according to claim 42, further comprising applying a time delay to the first returning light pulse in order to superimpose the two returning light pulses.

44. The method according to claim 42, wherein each light pulse comprises a plurality of light pulse components of different wavelengths, and wherein the detecting comprises demultiplexing the superimposed pairs of light pulses to obtain values corresponding to each wavelength component.

45. The method according to claim 44, wherein corresponding values from different wavelength components are computed to determine an unambiguous measure of the optical path length of the sensor over the full range of input signal amplitudes.

46. A method according to claim 44, wherein each light pulse includes two light pulse components whose wavelengths differ by 50 GHz.

47. A method for interrogating an optical sensor, in which an interrogating light pulse applied to the sensor produces a first returning light pulse unmodified by the sensor and a second returning light pulse modified by the sensor, the method comprising:
superimposing the first and second returning light pulses and detecting the result as a first value;
applying a predetermined phase shift in a first direction to one of the first and second returning light pulses to generate a third light pulse;
applying a predetermined phase shift in a second direction opposite to the first direction to the other of the first and second returning light pulses to generate a fourth light pulse;
superimposing the third light pulse on the other of the first and second returning light pulses and detecting the result as a fourth value;
superimposing the fourth light pulse on the other of the first and second returning light pulses and detecting the result as a fifth value; and
dividing the fifth value by the fourth value to obtain a sixth value representing a state of the sensor.

48. The method according to claim 47, further comprising applying a time delay to the first returning light pulse in order to superimpose the two returning light pulses.

49. The method according to claim 47, wherein each light pulse comprises a plurality of light pulse components of different wavelengths, and wherein the detecting comprises demultiplexing the superimposed pairs of light pulses to obtain values corresponding to each wavelength component.

50. The method according to claim 49, wherein corresponding values from different wavelength components are computed to determine an unambiguous measure of the optical path length of the sensor over the full range of input signal amplitudes.

51. The method according to claim 49, wherein each light pulse includes two light pulse components whose wavelengths differ by 50 GHz.

52. A seismic sensing array comprising a plurality of optical sensors, and apparatus for processing first and second optical signal pulses from an optical sensor, the apparatus comprising:
a first interferometer in which the first and second pulses are superimposed and a first value detected at a first detector means;
a second interferometer including means for applying a phase shift to one of the first and second pulses, in which the other of the first and second pulses and the phase-shifted pulse are superimposed and a second value detected at a second detector means;
means for dividing the first value by the second value to generate a third value; and
means for deriving data indicative of the state of the optical sensor on the basis of the third value.

53. A seismic sensing array comprising a plurality of optical sensors each having a respective optical path length, and apparatus for processing first and second optical signal pulses from at least one optical sensor, wherein each optical signal pulse comprises a plurality of optical signal pulse components of different wavelengths, the apparatus comprising:
a first interferometer in which the first and second pulses are superimposed;
a first demultiplexer for separating the wavelength components of the superimposed first and second pulses;
a first detector means to detect respective first values corresponding to each of the wavelength components of the superimposed first and second pulses;
means for applying a phase shift to one of the first and second pulses;
a second interferometer in which the other of the first and second pulses and the phase-shifted pulse are superimposed;
a second demultiplexer for separating the wavelength components of the superimposed phase-shifted pulse and other pulse;
a second detector means to detect respective second values corresponding to each of the wavelength components of the superimposed phase-shifted pulse and other pulse; and
determining means to determine a respective third value corresponding to each wavelength component and representing a measure of instantaneous optical path length of the sensor, on the basis of the first value and the second value corresponding to each wavelength component.

54. The seismic sensing array according to claim 53, wherein the applied phase shift is π/2 radians.

55. A method of operating a seismic sensing array, in which an interrogating light pulse comprising a plurality of optical signal pulse components of different wavelengths applied to the array produces from at least one sensor a first returning light pulse unmodified by the sensor and a second returning light pulse modified by the sensor, the method comprising:
superimposing the first and second returning light pulses;
separating the wavelength components of the superimposed first and second pulses;
detecting respective first values corresponding to each of the wavelength components of the superimposed first and second pulses;
applying a predetermined phase shift in a first direction to one of the first and second returning light pulses to generate a third light pulse;
superimposing the third light pulse on the other of the first and second returning pulses;
separating the wavelength components of the superimposed third pulse and other pulse;
detecting respective second values corresponding to each of the wavelength components of the superimposed third pulse and other pulse; and
determining a respective third value corresponding to each wavelength component and representing a measure of instantaneous path length of the sensor, on the basis of the first value and the second value corresponding to each wavelength component.
